(19) United States
(12) Patent Application Publication
(10) Pub. No.: US 2013/0148157 A1
(43) Pub. Date: Jun. 13, 2013

(54) IMAGE FORMING APPARATUS AND IMAGE FORMING METHOD

(71) Applicant: Tsumoru MATSUURA, Toyohashi-shi (JP)

(72) Inventor: Tsumoru MATSUURA, Toyohashi-shi (JP)

(21) Appl. No.: 13/693,195

(22) Filed: Dec. 4, 2012

(30) Foreign Application Priority Data
Dec. 9, 2011 (JP) 2011-270243

(51) Int. Cl. G06F 3/12

(52) U.S. Cl. CPC G06F 3/1237
USPC 358/1.15

(57) ABSTRACT

Disclosed is an image forming apparatus that includes: an inputting section to input first job data, serving as a base data group, and second job data, serving as an assembly of data for insertion, each of which is to be inserted into a inserting position of first job data, therefrom; a control section that divides second job data into plural sets of data for insertion so as to respectively insert plural sets of data for insertion into inserting positions of first job data, each of which is inserting position, and combines them with each other, in order to create a plurality of image forming use job data; and an image forming section to form images based on plurality of image forming use job data.

### BACKGROUND OF THE INVENTION

1. Field of the Invention

The present invention relates to an image forming apparatus and an image forming method, which are capable of coping with a variable printing operation.

2. Description of Related Art

Generally speaking, print data representing a direct mail or the like includes common data that represents an image being common among recipients of the direct mail concerned, such as a product explanation area, etc., and individual data that represents a customer name portion or the like, which is variable depending on the recipient address. Then, as a result of the variable printing operation employing the two kinds of data abovementioned, print products for the direct mail use are outputted.

In order to achieve the variable printing as abovementioned, conventionally employed is an exclusive application program to be executed for retrieving the individual data, representing the customer name, etc., from a database, and combining the retrieved individual data with the common data representing a form established in advance, etc., so as to create a plurality of individual print data sets, each of which is written in the Page Description Language. In this connection, JP3918251 (Japanese Patent Gazette), etc., sets forth such the variable printing method for combining the abovementioned individual data and the common data with each other.

In order to combine the individual data and the common data with each other by employing the abovementioned application program, it is necessary to make a computer, currently incorporated in a client terminal device or a server, execute an exclusive application program. Further, it may be inconvenient for such a user, who scarcely uses the program and is not sufficiently accustomed to using the program concerned, to make the computer execute the exclusive application program, on the points that he should newly arrange the usage environment and learn the way of consecutive operations in regard to the program concerned. In addition to the above, there arises another problem that, since the PDL data, written in the Page Description Language, is created by executing the exclusive application program, it is impossible to easily grasp the finished state of print products concerned.

On the other hand, according to such a method in which the user uses a document creating application program at the computer terminal device to create document data sets, each of which is a combination of the individual data and the common data and a number of which is equal to the number of individual data sets, and then, all of the documents are printed on the basis of the document data sets above-created, it becomes comparatively easy even for such the user, who scarcely uses the program and is not sufficiently accustomed to using the program concerned, to implement the document printing, since the printing image can be easily grasped and the exclusive application program is not necessary.

However, according to the abovementioned method, the number of operations to be manually conducted by the user inevitably increases, and as a result, a number of times a mistake occurs or is overlooked possibly increases as well. Further, since it is necessary to transmit all of the print data sets, the number of which is equal to that of the individual data sets, to the printer, there newly arises such a problem that the data traffic in the concerned network will considerably increase.

The present invention is achieved in view of the abovementioned subjects, and one of the objects of the present invention is to provide an image forming apparatus and an image forming method, each of which makes it possible to conduct the variable printing without employing the exclusive application program and without requiring any expertise or mastership of the user.

In order to attain at least one of the objects of the present invention, according to an image forming apparatus reflecting an aspect of the present invention, the image forming apparatus comprises: an inputting section to input first job data, serving as a base data group, and second job data, serving as an assembly of data for insertion, each of which is to be inserted into a inserting position of the first job data, therefrom; a control section that divides the second job data into plural sets of the data for insertion so as to respectively insert the plural sets of the data for insertion into inserting positions of the first job data, each of which is the inserting position, and combines them with each other, in order to create a plurality of image forming use job data; and an image forming section to form images based on the plurality of image forming use job data.

According to still another aspect of the present invention, in the image forming apparatus recited in the above, it is desirable that the control section makes “n” copies of the first job data, and divides the second job data into “n” sets of the data for insertion, so as to respectively insert the “n” sets of the data for insertion into the inserting positions, each of which is provided in each of the “n” copies of the first job data.

According to still another aspect of the present invention, in the image forming apparatus recited in the foregoing, it is desirable that the first job data is defined as common job data to be commonly employed among the plurality of image forming use job data; and the second job data is defined as divided insertion job data, serving as the assembly of data for insertion that is constituted by insertion use page data, being dividable into page data for every page.

According to still another aspect of the present invention, in the image forming apparatus recited in the foregoing, it is desirable that insertion use page data, created by dividing the second job data for every single page or for every plurality of pages or at an arbitral position, can be inserted into the inserting position as the data for insertion.

According to still another aspect of the present invention, in the image forming apparatus recited in the foregoing, it is desirable that a plurality of inserting positions is settable, and a plurality of the second job data is employed in conformity with the plurality of inserting positions.

According to still another aspect of the present invention, in the image forming apparatus recited in the foregoing, it is desirable that, based on settings established for every one of the data for insertion, the control section establishes settings for implementing an image forming operation in regard to every one of the image forming use job data.

According to yet another aspect of the present invention, in the image forming apparatus recited in the foregoing, it is desirable that it is possible to established a setting of “valid” representing that the image forming operation is to be implemented, or “invalid” representing that the image forming operation is not to be implemented, for every one of pages included in both the first job data and the second job data.

### BRIEF DESCRIPTION OF THE DRAWINGS

FIG. 1 shows a block diagram indicating a configuration of an image forming apparatus embodied in the present invention.

FIG. 2 shows a flowchart indicating operations to be conducted in an image forming apparatus embodied in the present invention.

FIG. 3 shows an explanatory schematic diagram indicating an example of screen display of an image forming apparatus embodied in the present invention.

FIG. 4 shows an explanatory schematic diagram indicating another example of screen display of an image forming apparatus embodied in the present invention.

FIG. 5 shows an explanatory schematic diagram indicating an operation of the image forming apparatus embodied in the present invention.

FIG. 6 shows an explanatory schematic diagram indicating another operation of the image forming apparatus embodied in the present invention.

FIG. 7 shows a flowchart indicating operations to be conducted in an image forming apparatus embodied in the present invention.

FIG. 8 shows an explanatory schematic diagram indicating still another example of screen display of an image forming apparatus embodied in the present invention.

FIG. 9 shows an explanatory schematic diagram indicating still another operation of the image forming apparatus embodied in the present invention.

FIG. 10 shows an explanatory schematic diagram indicating still another operation of the image forming apparatus embodied in the present invention.

FIG. 11 shows a flowchart indicating operations to be conducted in an image forming apparatus embodied in the present invention.

FIG. 12 shows an explanatory schematic diagram indicating still another example of screen display of an image forming apparatus embodied in the present invention.

FIG. 13 shows an explanatory schematic diagram indicating still another operation of the image forming apparatus embodied in the present invention.

FIG. 14 shows an explanatory schematic diagram indicating still another example of screen display of an image forming apparatus embodied in the present invention.

FIG. 15 shows an explanatory schematic diagram indicating still another example of screen display of an image forming apparatus embodied in the present invention.

FIG. 16 shows an explanatory schematic diagram indicating still another example of screen display of an image forming apparatus embodied in the present invention.

FIG. 17 shows an explanatory schematic diagram indicating yet another example of screen display of an image forming apparatus embodied in the present invention.

FIG. 18 shows an explanatory schematic diagram indicating yet another operation of the image forming apparatus embodied in the present invention.

### DETAILED DESCRIPTION OF THE INVENTION

Referring to the drawings, preferred embodiments of the present invention will be detailed in the following. Herein, an image forming apparatus 100, which can serve as a copier, a scanner, printer, etc., and is provided with a function for storing data, will be detailed as a concrete example.

### <Configuration of Image Forming Apparatus>

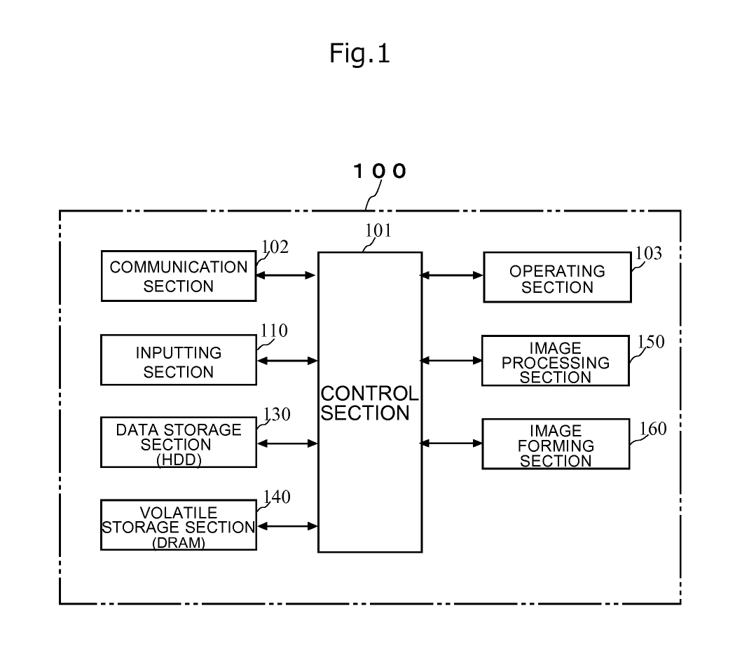

As shown in FIG. 1, the image forming apparatus 100 is constituted by a control section 101, a communication section 102, an operating section 103, an inputting section 110, a data storage section 130, a volatile storage section 140, an image processing section 150 and an image forming section 160.

In this connection, the control section 101 is constituted by a CPU (Central Processing Unit), etc., so as to control various kinds of operation to be conducted by the sections included in the image forming apparatus 100. The communication section 102 communicates with other apparatuses through various kinds of networks. The operating section 103 is constituted by a LCD (Liquid Crystal Display) section, a touch panel, etc., so as to accept input operations conducted by the user and to display various kinds of information in regard to the apparatus concerned.

The inputting section 110 inputs job data, scanned data, etc., transmitted through a network and/or an interface (both not shown in the drawings), therein. The data storage section 130 stores various kinds of data to be processed in the image forming apparatus 100 into an HDD (Hard Disc Drive) serving as a nonvolatile storage device. The volatile storage section 140 includes a working area to be used at the time when performing various kinds of processing.

The image processing section 150 applies a raster image processing (or a RIP (Raster Image Processor) processing) to print data, included in the print job concerned and written in the Page Description Language, so as to generate bitmap image data, and further, applies a compression processing and/or an expansion processing to the bitmap image data in order to appropriately store the processed image data. The image forming section 160 is sometimes called a print engine, and forms images onto a paper sheet or the like by employing an electro-photographic method, etc.

Further, first job data, serving as a group of base data sets, and second job data, being an assembly of data for insertion sets, each of which is to be inserted into each of inserting positions provided in the first job data, are inputted from an external computer terminal device (not shown in the drawings) currently operated by the user, into the image forming apparatus 100 through the inputting section 110.

In this connection, hereinafter, the first job data serving as a group of base data sets can be also referred to as first job data serving as such a group of data sets that represent a main portion of an image to be formed.

Still further, the control section 101 conducts such controlling operations that include: creating “n” copies of the first job data and dividing the second job data into “n” sets of the data for insertion; inserting each of the “n” sets of the data for insertion into a corresponding one of the inserting positions of each of the “n” copies of the first job data; connecting them with each other so as to generate plural sets of image-forming use job data; and implementing image forming operations based on the plural sets of image-forming use job data above-generate.

Yet further, although apparatuses to be possibly coupled to the image forming apparatus 100, such as a paper sheet feeding apparatus, various kinds of post processing apparatuses, etc., are not shown in the FIG. 1 and not specifically described in the foregoing, it is needless to say that such the various kinds of apparatuses can be coupled to the image forming apparatus 100 as needed. Further, even when such the other apparatuses is coupled to the image forming apparatus 100, the control section 101 conducts operations for controlling each of the apparatuses as needed.

### <Operations (1) of Image Forming Apparatus>

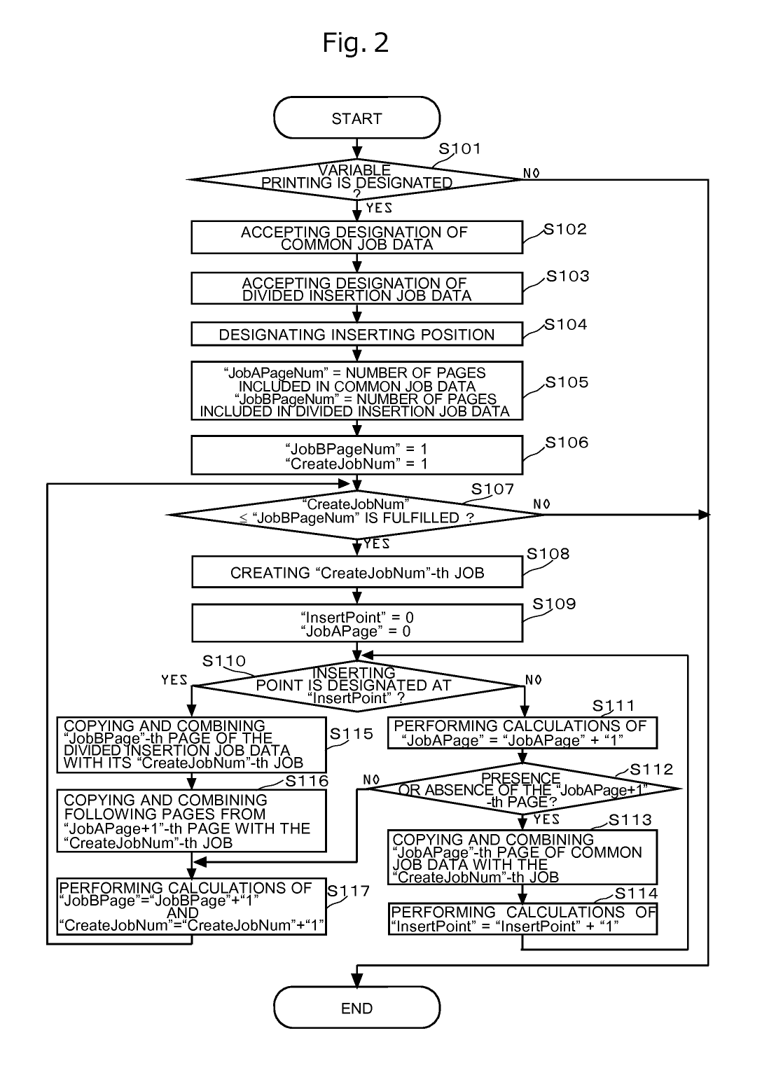

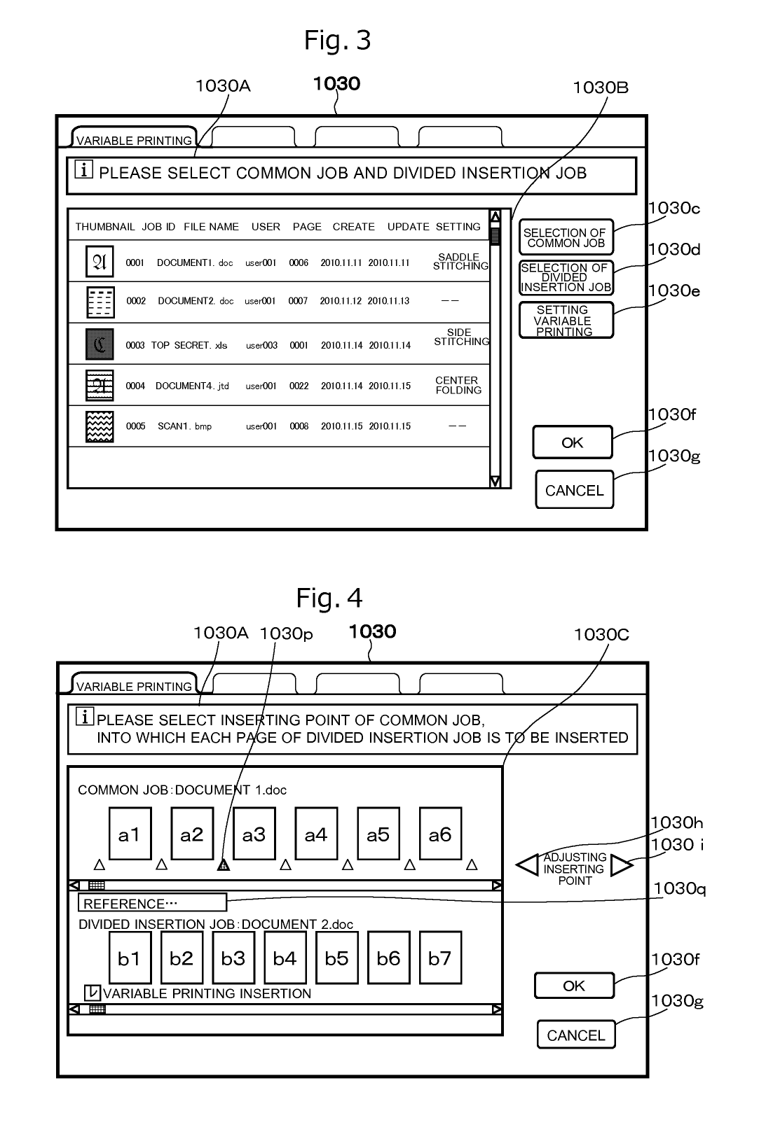

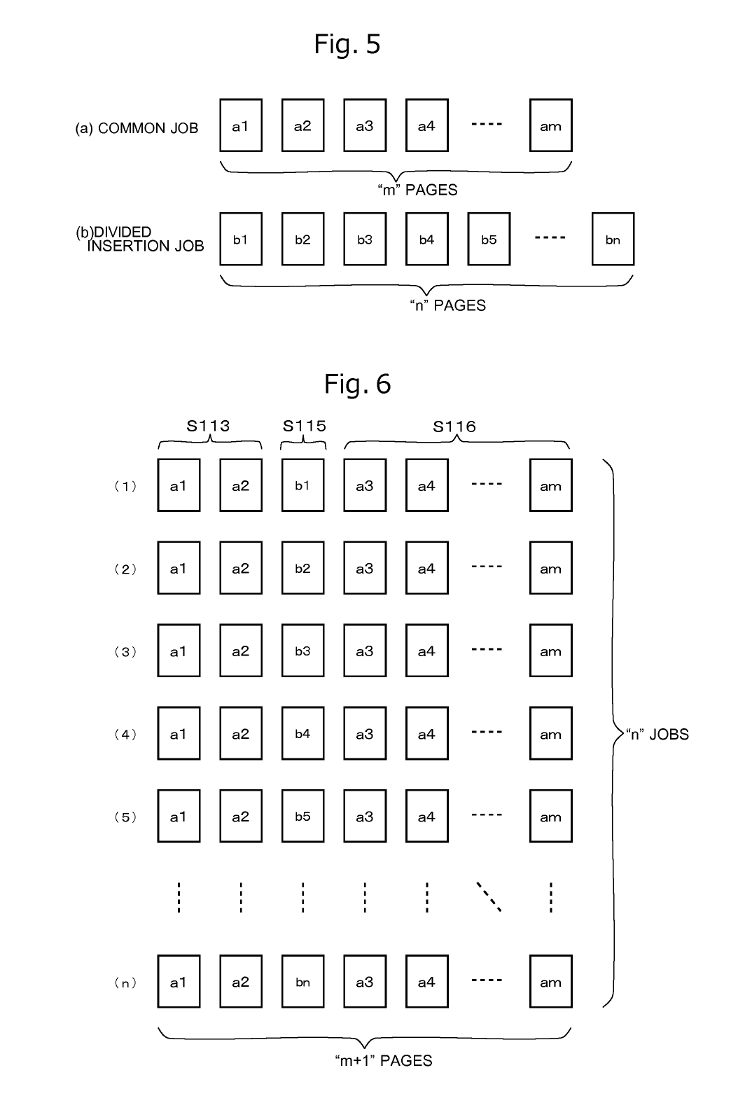

Now, referring to the flowchart shown in FIG. 2, the explanatory schematic diagrams of the screen displays shown in FIG. 3 and FIG. 4, and the explanatory schematic diagrams of the job statuses shown in FIG. 5 and FIG. 6, the operations to be conducted in the image forming apparatus 100, serving as an embodiment of the present invention, a configuration of which is exemplified as the schematic diagram shown in FIG. 1, will be detailed in the following.

Initially, the control section 101 monitors a current operating status of the operating section 103 and the data communication status in regard to data sent from the external apparatuses so as to determine whether or not the user currently instructs a designation of the variable printing (Step S101 shown in FIG. 2). In this connection, it is applicable that the designation of the variable printing is instructed (inputted) from the computer terminal device installed in the user's site, or through the operating section 103 provided in the image forming apparatus 100.

When determining that the user instructs the designation of the variable printing from the operating section 103 or the computer terminal device coupled to the network concerned (Step S101; YES, shown in FIG. 2) and accepting the user's instruction concerned, the control section 101 further accepts designations of common job data and divided insertion job data (Step S102 and Step S103, shown in FIG. 2).

Hereinafter, the common job data is defined as the first job data serving as the group of base data sets. In other words, such data that is commonly used within the job data to be employed for the image forming operation is called common job data. Further, the divided insertion job data is defined as the second job data, being an assembly of the data for insertion sets, each of which is to be inserted into each of the inserting positions provided in the first job data. In other words, the assembly of the data for insertion sets, constituted by insertion use page data that is dividable for every page, is called the divided insertion job data.

In this connection, when taking the direct mail as a concrete example, data of the page concerning to the product description corresponds to the common job data defined as the first job data, while other data of the other page concerning to the greeting message for each of the customers corresponds to the divided insertion job data defined as the second job data.

Further, the operation to be conducted by the control section 101 for accepting the designations of the common job data and the divided insertion job data may be any one of operations for: receiving data sent from the computer terminal device currently operated by the user through the inputting section 110 at that time point; designating specific data sets, inputted in advance and currently stored into the data storage section 130, from the operating section 103; and designating specific data sets, inputted in advance and currently stored into the data storage section 130, from the computer terminal device currently operated by the user.

When the user designates specific data sets, inputted in advance and currently stored into the data storage section 130, from the operating section 103, the control section 101 refers to the data storage section 130, the computer terminal device on the network, etc., so as to display a setting screen 1030 onto the operating section 103, and displays a message for accepting the designations of the common job data and the divided insertion job data on an area 1030A provided in the setting screen 1030 shown in FIG. 3, and further displays a list of job data, currently stored in the data storage section 130, as a job-data list display screen on an area 1030B provided in the setting screen 1030 shown in FIG. 3. Accordingly, the user can designate the desired common job data and the divided insertion job data from the job data sets indicated in such the job-data list display screen.

In this connection, under the controlling operations conducted by the control section 101, various kinds of information, including a thumbnail-size image of job data, a job ID, a file name, a managing user's name, a number of pages, a date of latest update, a setting for post processing, etc., which correspond to each of the job data sets, are also displayed on the job-data list display screen 1030B, so as to assist the job data selecting operation to be conducted by the user.

For instance, the user selects any one of the job data sets indicated in the job-data list display screen 1030B, and further depresses a common job data selection tub 1030c to designate the common job data. Further, the user selects any one of the job data sets indicated in the job-data list display screen 1030B, and further depresses a divided-insertion job data selection tub 1030d to designate the divided insertion job data. It is applicable that the order of the tub depressing operation and the job data selecting operation is reversed. Successively, when the user depresses either a variable printing setting tub 1030e or an OK tub 1030f, the control section 101 further continues to conduct processing and controlling operations.

When the user designates the inserting position for the variable printing through the operating section 103, the control section 101 displays the setting screen 1030 shown in FIG. 4, in which pages (a1, a2, a3 - - - ) to be included in the common job data are also displayed, and arranges a pointer 1030p for indicating the designated inserting position at a position between the pages. In this connection, the pointer 1030p may be operated by using a pointing device, or by using position adjusting buttons 1030h and 1030i, and it is possible for the user to determine a desired position as the inserting position by depressing the OK button 1030f (Step S104 shown in FIG. 2).

The example shown in FIG. 4 indicates such a state that the pointer 1030p is positioned between the 2-page and the 3-page so as to establish an inserting-position determination variable number (hereinafter, referred to as “InsertPoint”) as “InsertPoint”=2. Further, when the user also designates the divided insertion job data from the setting screen 1030 shown in FIG. 4, by clicking a referring operation section 1030q, it becomes possible to select the divided insertion job data from the data storage section 130, the computer terminal device on the network, etc.

In this connection, hereinafter, a string of characters, noted in a pair of brackets of “ - - - ”, represents a numeral value of an item defined by the string of characters concerned, in principle. Further, when the numeral value of the item defined by the string of characters is any one of “1”, “2” and “3”, the symbol of -th to be attached to the abovementioned pair of brackets of “ - - - ” should be replaced with any one of -st, -nd and -rd, corresponding to the numeral values of “1”, “2” and “3”, respectively.

The control section 101 acquires a number of pages included in the common job data designated by the user (hereinafter, referred to as “JobAPageNum”) (Step S105 shown in FIG. 2). In the example shown in FIG. 5, since the common job data includes “m” pages, “JobAPageNum”=m is established. Further, the control section 101 acquires a number of pages included in the divided insertion job data designated by the user (hereinafter, referred to as “JobBPageNum”) (Step S105 shown in FIG. 2). In the example shown in FIG. 5, since the divided insertion job data includes “n” pages, “JobBPageNum”=n is established.

Successively, the control section 101 sets an initial value of a variable number of divided insertion job processing pages (hereinafter, referred to as “JobBPage”) at zero, and also sets an initial value of a number of image-forming use job data sets to be created (hereinafter, referred to as “CreateJobNum”) at 1 (Step S106 shown in FIG. 2), and then, determines whether or not the formula of “CreateJobNum”≦“JobBPageNum” is fulfilled (Step S107 shown in FIG. 2).

In this connection, when determining that the formula of “CreateJobNum” “JobBPageNum” is not fulfilled (Step S107; NO, shown in FIG. 2), the control section 101 fmalizes the processing (END shown in FIG. 2). Concretely speaking, this means that, in the example shown in FIG. 5, it is established to create “n” sets of image forming use job data so as to make it in conformity with the number of divided insertion job data sets.

On the other hand, when determining that the formula of “CreateJobNum”≦“JobBPageNum” is still fulfilled (Step S107; YES, shown in FIG. 2), the control section 101 creates the “CreateJobNum”-th job (Step S108 shown in FIG. 2). In this connection, data of each of the pages, included in the job above-created, is created by copying necessary page data and combining them with each other according to the processing described in the following.

Herein, the control section 101 sets an initial value of “InsertPoint”, serving as the inserting-position determination variable number of the insertion use job in the common job data, at zero, and also sets an initial value of a variable number of common job processing pages (hereinafter, referred to as “JobAPage”) at zero (Step S109 shown in FIG. 2).

Successively, the control section 101 determines whether or not the inserting point is designated at “InsertPoint”, serving as the inserting-position determination variable number (Step S110 shown in FIG. 2). When determining that the inserting point is not designated at the initial value “0” (at one page previous position of the common job) of “InsertPoint”, serving as the inserting-position determination variable number (Step S110; NO, shown in FIG. 2), the control section 101 adds “1” to “JobAPage” (Step S111 shown in FIG. 2).

Still successively, when determining that the “JobAPage+1”-th page exists (Step S112; YES shown in FIG. 2), the control section 101 copies the “JobAPage”-th page of the common job data and combine the “JobAPage”-th page with the “CreateJobNum”-th job (Step S113 shown in FIG. 2).

Yet successively, the control section 101 adds “1” to “InsertPoint”, serving as the inserting-position determination variable number (Step S114 shown in FIG. 2) and repeats the flow of the consecutive operations for: determining presence or absence of the designation of the inserting point at the next page position (Step S110 shown in FIG. 2); adding “1” to “JobAPage” (Step S111 shown in FIG. 2); determining presence or absence of the “JobAPage+1”-th page (Step S112; YES shown in FIG. 2); and performing copying and combining operations of the “JobAPage”-th page of the common job data (Step S113 shown in FIG. 3), until determining that the inserting point is designated (Step S110; YES shown in FIG. 2).

In other words, until the designation of the inserting position is found (Step S110; YES shown in FIG. 2), or until the “JobAPage+1”-th page does not exist (Step S112; NO shown in FIG. 2), the control section 101 repeats the copying and combining operations of the “JobAPage”-th page of the common job data (Step S113 shown in FIG. 3). Further, when the “JobAPage+1”-th page does not exist (Step S112; NO shown in FIG. 2), in order to conduct processing for the next job, the control section 101 performs a calculation of “JobAPage”=“JobAPage”+“1”, and then, adds “1” to “CreateJobNum” and implements the processing in regard to the next job (Step S117 shown in FIG. 2) to repeat the same processing as abovementioned.

According to this processing, the control section 101 sequentially copies and combines the common job data with the “CreateJobNum”-th job one by one from the first page of the common job data to the page position at the inserting position, or to the final page of the common job data when the inserting position is not designated.

Returning to the flowchart, the control section 101 determines whether or not the inserting point is designated at “InsertPoint”, serving as the inserting-position determination variable number (Step S110 shown in FIG. 2). When determining that the inserting point is designated at “InsertPoint”, serving as the inserting-position determination variable number (Step S110; YES, shown in FIG. 2), the control section 101 copies and combines the “JobBPage”-th page of the divided insertion job data with its “CreateJobNum”-th job (Step S115 shown in FIG. 2).

Successively, the control section 101 copies and combines the following pages from the “JobAPage+1”-th page with the “CreateJobNum”-th job, for processing the next job (Step S116 shown in FIG. 2). After that, the control section 101 performs a calculation of “JobBPage”=“JobBPage”+“1”, and then, adds “1” to “CreateJobNum” and implements the processing in regard to the next job (Step S117 shown in FIG. 2) to repeat the same processing as abovementioned.

In other words, if the designation of the inserting position is found (Step S110; YES shown in FIG. 2), the control section 101 brakes and combine the “JobBPage”-th page of the divided insertion job data with the next to “JobAPage” of the common job data of its “CreateJobNum”-th job (Step S115 shown in FIG. 2), and further, copies and combines the following pages from the “JobAPage+1”-th page with the “CreateJobNum”-th job (Step S116 shown in FIG. 2).

Still successively, the control section 101 repeatedly implements the abovementioned processing in regard to the “CreateJobNum”-th job (Step S108 through Step S117, shown in FIG. 2), starting from numeral “1” as a start point and finalizing at “JobBPageNum” as an end point (Step S107 shown in FIG. 2). In this connection, when determining that the formula of “CreateJobNum”≦“JobBPageNum” is not fulfilled (Step S107; NO, shown in FIG. 2), the control section 101 fmalizes the processing (END shown in FIG. 2). Concretely speaking, this means that the control section 101 creates the image-forming use job data sets, so as to make the number thereof in conformity with the number of divided insertion job data sets.

As shown in FIG. 4, in such a case that the pointer 1030p is inserted between 2 and 3 pages so as to established the equation of “InsertPoint”=2, serving as the inserting-position determination variable number, and the equations of “JobAPageNum”=“m” and “JobBPageNum”=“n” are established as shown in FIG. 5, the image forming use jobs are finally created as shown in FIG. 6. Incidentally, the reference numbers of S113, S115 and S116, shown in FIG. 6, indicates the same processing steps as those indicated in the flowchart shown in FIG. 2, for your reference. As shown in FIG. 6, by inserting each of the insertion use page data sets, separated from the divided insertion job data, into the common job data including “m” pages, total “n” jobs, each of which includes “m+1” pages and the number of which is equivalent to the number of pages included in the divided insertion job data, are created.

Yet successively, the control section 101 stores the image forming use job data, created through the abovementioned processing, into the data storage section 130, etc., in an arbitral format, such as a single job data format, a plural job data format, etc.

In this case, since transferred from the computer terminal device to the image forming apparatus 100 are only the common job data and the divided insertion job data, both shown in FIG. 5, no duplication of transferring data exist. Accordingly, since an amount of data to be transferred can be reduced at a minimum level, it becomes possible to contribute to improvement of the data traffic efficiency of the network concerned.

Further, since it is only required for the user to provide the common job data, serving as the group of base data sets, and the divided insertion job data, being the assembly of the data for insertion sets to be respectively inserted into the inserting positions, the exclusive application program and/or the expertise or mastership of the user become unnecessary.

Still further, since the processing to be conducted in the image forming apparatus 100 side is merely a fixed procedure of simple consecutive operations, including: copying “n” sets of common job data; dividing the divided insertion job data down to the insertion use page data; inserting the insertion use page data into the inserting position; and combining the inserted data, the exclusive application program to be executed for implementing complicated processing also becomes unnecessary.

In other words, it becomes possible to conduct the variable printing without employing the exclusive application program and without requiring any expertise or mastership of the user, while reducing the data transferring amount.

### <Operations (2) of Image Forming Apparatus>

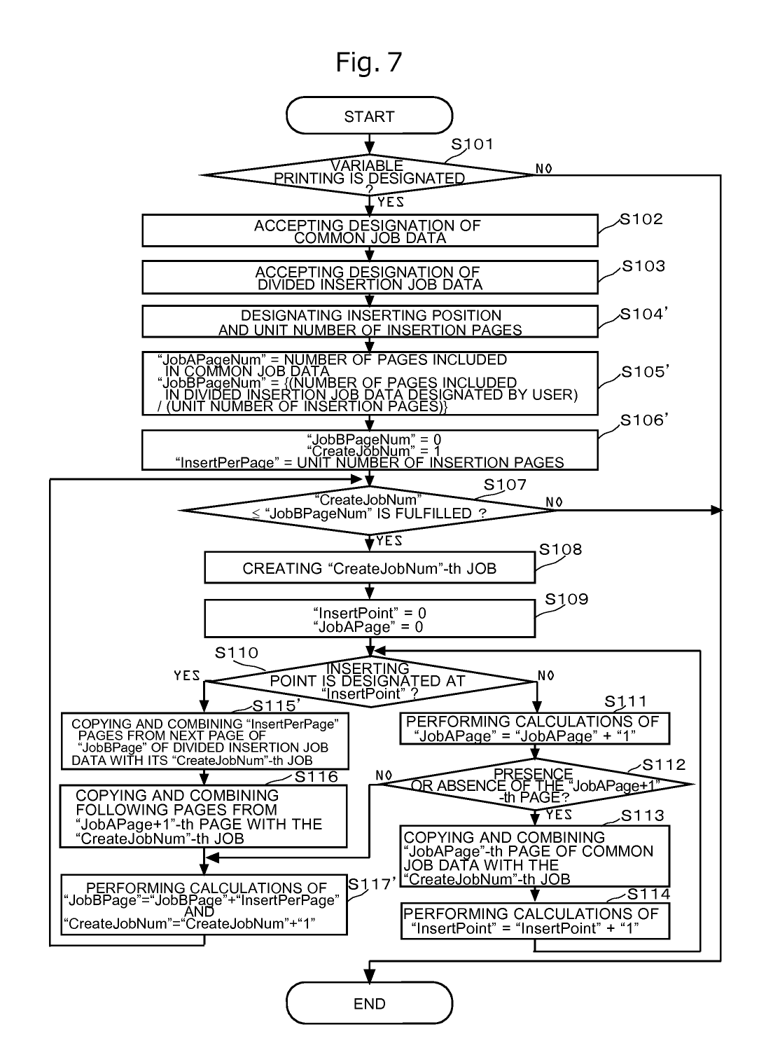

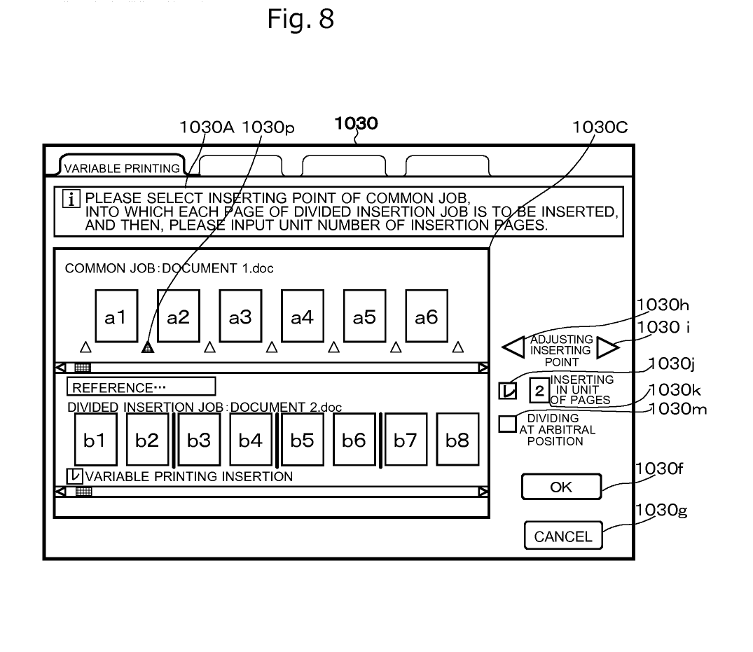

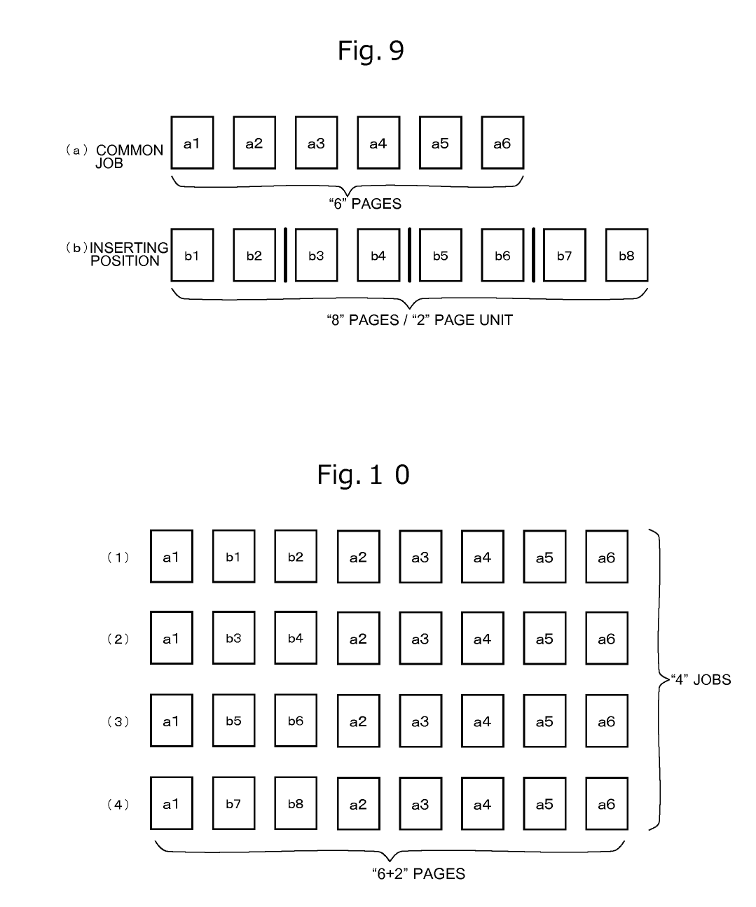

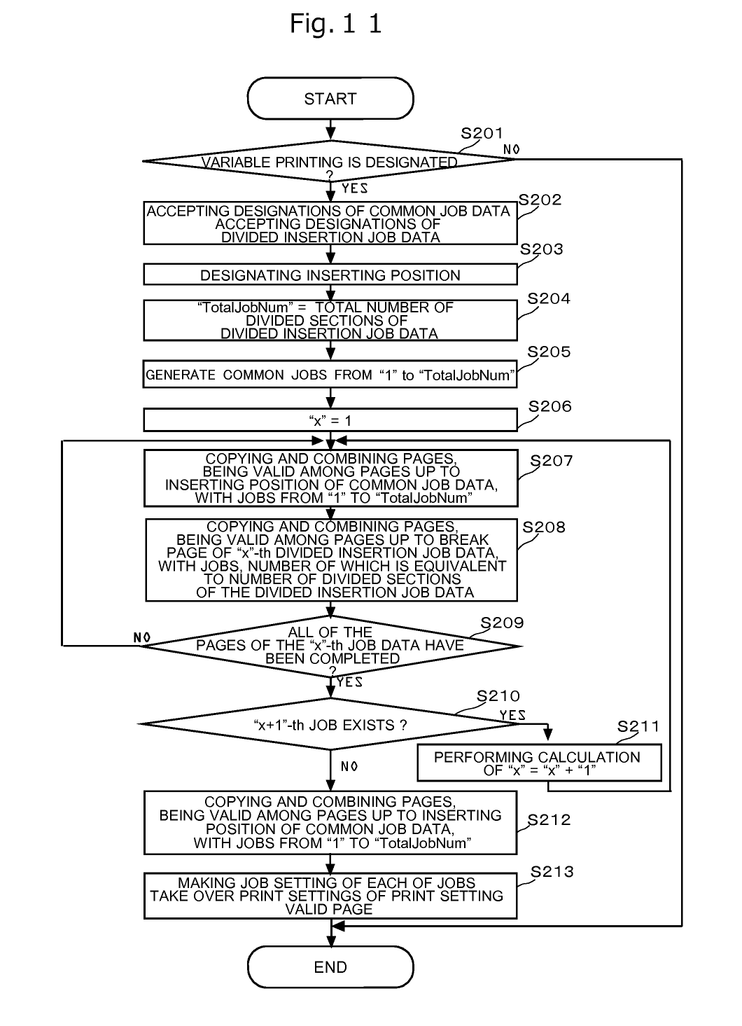

Next, referring to the flowchart shown in FIG. 7, the explanatory schematic diagram of the screen display shown in FIG. 8, and the explanatory schematic diagrams of the job statuses shown in FIG. 9 and FIG. 10, the operations to be conducted in the image forming apparatus 100, serving as another embodiment of the present invention, will be detailed in the following as OPERATIONS (2) OF IMAGE FORMING APPARATUS. In this connection, in the flowchart shown in FIG. 7, the reference numbers of the steps, representing the same processing contents as those represented by the steps included in the flowchart shown in FIG. 2, are the same as those attached to the same steps in the flowchart shown in FIG. 2, respectively, so as to omit or simplify duplicated explanations for them. Further, in the flowchart shown in FIG. 7, the mark of n is attached to the trailing portion of the reference number of each of the steps, the processing contents of which are analogous to those of the steps included in the flowchart shown in FIG. 2, in order to indicate that the processing content of the step attached with the mark of [′] is partially different from that of the step, having the same reference number in the flowchart shown in FIG. 2, though both of them are analogous to each other.

When determining that the user instructs the designation of the variable printing (Step S101; YES, shown in FIG. 7) and accepting the user's instruction concerned, the control section 101 further accepts designations of common job data and divided insertion job data (Step S102 and Step S103, shown in FIG. 7).

When the user designates the inserting position for the variable printing through the operating section 103, the control section 101 displays the setting screen 1030 shown in FIG. 8, in which pages (a1, a2, a3 ---) to be included in the common job data, a pointer 1030p for indicating the designated inserting position and an inputting item 1030k for inputting a unit number of insertion pages, are also displayed.

Successively, the user moves pointer 1030p at a desired position to designate the inserting position, inputs a value into the inputting item 1030k, and then, depresses the OK button 1030f so as to determine the current settings (Step S104′ shown in FIG. 7).

In the example shown in FIG. 8, the pointer 1030p is positioned between the 1-page and the 2-page so as to establish the equation of “InsertPoint”=1, serving as the inserting-position determination variable number. Further, numeral 2 is inputted as a unit number of insertion pages (hereinafter, referred to as “InsertPerPage”). Incidentally, if numeral 1 were inputted into the inputting item 1030k as the unit number of insertion pages, following operations would be the same as those of OPERATIONS (1) aforementioned.

Still successively, the control section 101 acquires “JobAPageNum”, representing the number of pages included in the common job data designated by the user (Step S105′ shown in FIG. 7). In the example shown in FIG. 9, since the common job data includes 6 pages, the equation of “JobAPageNum”=6 is established. Further, the control section 101 acquires “JobBPageNum”, derived by the formula of “JobBPageNum”={(number of pages included in divided insertion job data designated by user)/(unit number of insertion pages)], (Step S105′ shown in FIG. 7). In the example shown in FIG. 9, since the divided insertion job data includes “8” pages and the unit number of insertion pages is set at “2”, “JobBPageNum”=8/2=4 is acquired.

Still successively, the control section 101 sets an initial value of “JobBPage”, representing the variable number of divided insertion job processing pages, at “1”, also sets the initial value of “CreateJobNum”, representing the number of image-forming use job data sets to be created, at 1, and further establishes the equation of “InsertPerPage”=2 (Step S106′ shown in FIG. 7), and then, determines whether or not the formula of “CreateJobNum”≦“JobBPageNum” is fulfilled (Step S107 shown in FIG. 7). In this connection, when determining that the formula of “CreateJobNum”≦“JobBPageNum” is not fulfilled (Step S107; NO, shown in FIG. 7), the control section 101 fmalizes the processing (END shown in FIG. 7). Concretely speaking, this means that, in the example shown in FIG. 9, it is established to create “8/2” sets of image forming use job data so as to make it in conformity with the number of divided insertion job data sets.

On the other hand, when determining that the formula of “CreateJobNum”≦“JobBPageNum” is still fulfilled (Step S107; YES, shown in FIG. 7), the control section 101 creates the “CreateJobNum”-th job (Step S108 shown in FIG. 7). In this connection, data of each of the pages, included in the job above-created, is created by copying necessary page data and combining them with each other according to the processing described in the following.

Herein, the control section 101 sets the initial value of “InsertPoint”, serving as the inserting-position determination variable number of the insertion use job in the common job data, at zero, and also sets the initial value of “JobAPage”, serving as the variable number of common job processing pages, at zero (Step S109 shown in FIG. 7).

Successively, the control section 101 determines whether or not the inserting point is designated at “InsertPoint”, serving as the inserting-position determination variable number (Step S110 shown in FIG. 7). When determining that the inserting point is not designated at the initial value “0” (at one page previous position of the common job) of “InsertPoint”, serving as the inserting-position determination variable number (Step S110; NO, shown in FIG. 7), the control section 101 adds “1” to “JobAPage” (Step S111 shown in FIG. 7).

Still successively, when determining that the “JobAPage+1”-th page exists (Step S112; YES shown in FIG. 7), the control section 101 copies the “JobAPage”-th page of the common job data and combine the “JobAPage”-th page with the “CreateJobNum”-th job (Step S113 shown in FIG. 7).

Yet successively, the control section 101 adds “1” to “InsertPoint”, serving as the inserting-position determination variable number (Step S114 shown in FIG. 7) and repeats the flow of the consecutive operations for: determining presence or absence of the designation of the inserting point at the next page position (Step S110 shown in FIG. 7); adding “1” to “JobAPage” (Step S111 shown in FIG. 7); determining presence or absence of the “JobAPage+1”-th page (Step S112; YES shown in FIG. 7); and performing copying and combining operations of the “JobAPage”-th page of the common job data (Step S113 shown in FIG. 7), until determining that the inserting point is designated (Step S110; YES shown in FIG. 7).

In other words, until the designation of the inserting position is found (Step S110; YES shown in FIG. 7), or until the “JobAPage+1”-th page does not exist (Step S112; NO shown in FIG. 7), the control section 101 repeats the copying and combining operations of the “JobAPage”-th page of the common job data (Step S113 shown in FIG. 7). Further, when the “JobAPage+1”-th page does not exist (Step S112; NO shown in FIG. 7), in order to conduct processing for the next job, the control section 101 performs a calculation of “JobAPage”=“JobAPage”+“1”, and then, adds “1” to “CreateJobNum” and implements the processing in regard to the next job (Step S117′ shown in FIG. 7) to repeat the same processing as abovementioned.

According to this processing, the control section 101 sequentially copies and combines the common job data with the “CreateJobNum”-th job one by one from the first page of the common job data to the page position at the inserting position, or to the final page of the common job data when the inserting position is not designated.

Returning to the flowchart, the control section 101 determines whether or not the inserting point is designated at “InsertPoint”, serving as the inserting-position determination variable number (Step S110 shown in FIG. 7). When determining that the inserting point is designated at “InsertPoint”, serving as the inserting-position determination variable number (Step S110; YES, shown in FIG. 7), the control section 101 copies and combines the “InsertPerPage” pages from the next page of the “JobBPage” of the divided insertion job data with its “CreateJobNum”-th job (Step S115′ shown in FIG. 7). In Step S115′, the divided insertion job data is divided in increments of 2 pages so as to insert them into the common job data.

Successively, the control section 101 copies and combines the following pages from the “JobAPage+1”-th page with the “CreateJobNum”-th job, (Step S116 shown in FIG. 7). After that, for processing next job, the control section 101 performs a calculation of “JobBPage”=“JobBPage”+“InsertPerPage”, and then, adds “1” to “CreateJobNum” and implements the processing in regard to the next job (Step S117′ shown in FIG. 7) to repeat the same processing as abovementioned.

In other words, if the designation of the inserting position is found (Step S110; YES shown in FIG. 7), the control section 101 extracts the “InsertPerPage” pages from the next page of the “JobBPage” of the divided insertion job data and combines the “InsertPerPage” pages, above-extracted, with the page next to the “JobAPage” of the common job data of its “CreateJobNum”-th job (Step S115 shown in FIG. 2), and further, copies and combines the following pages from the “JobAPage+1”-th page with the “CreateJobNum”-th job (Step S116 shown in FIG. 7).

Still successively, the control section 101 repeatedly implements the abovementioned processing in regard to the “CreateJobNum”-th job (Step S108 through Step S117′, shown in FIG. 7), starting from numeral “1” as a start point and finalizing at “JobBPageNum” as an end point (Step S107 shown in FIG. 7). In this connection, when determining that the formula of “CreateJobNum”≦“JobBPageNum” is not fulfilled (Step S107; NO, shown in FIG. 7), the control section 101 fmalizes the processing (END shown in FIG. 7). Concretely speaking, this means that the control section 101 creates the image-forming use job data sets, so as to make the number thereof in conformity with “JobBPageNum”.

As shown in FIG. 8, in such a case that the pointer 1030p is inserted between 1 and 2 pages so as to established the equation of “InsertPoint”=1, serving as the inserting-position determination variable number, and the equations of “JobAPageNum”=“6” and “JobBPageNum”=“8/2” are established as shown in FIG. 9, the image forming use jobs are finally created as shown in FIG. 10. As shown in FIG. 10, by inserting the insertion use page data sets for the “InsertPerPage” pages, extracted from the divided insertion job data, into the common job data including “6” pages, total 4 jobs, each of which includes “6+2” pages and the number of which is equivalent to “JobBPageNum”, are created.

Yet successively, the control section 101 stores the image forming use job data, created through the abovementioned processing, into the data storage section 130, etc., in an arbitral format, such as a single job data format, a plural job data format, etc.

In this case, as shown in FIG. 9, since no duplication of data, to be transferred from the computer terminal device to the image forming apparatus 100, exist, an amount of data to be transferred can be reduced at a minimum level, and accordingly, it becomes possible to contribute to improvement of the data traffic efficiency of the network concerned. Further, since it is only required for the user to provide the common job data and the divided insertion job data, the exclusive application program and/or the expertise or mastership of the user become unnecessary. Still further, since the processing to be conducted in the image forming apparatus 100 side is merely a fixed procedure of simple consecutive operations, including a copying operation, a dividing operation, an inserting operation and a combining operation, the exclusive application program to be executed for implementing complicated processing also becomes unnecessary. In other words, it becomes possible to conduct the variable printing without employing the exclusive application program and without requiring any expertise or mastership of the user, while reducing the data transferring amount

### <Operations (3) of Image Forming Apparatus>

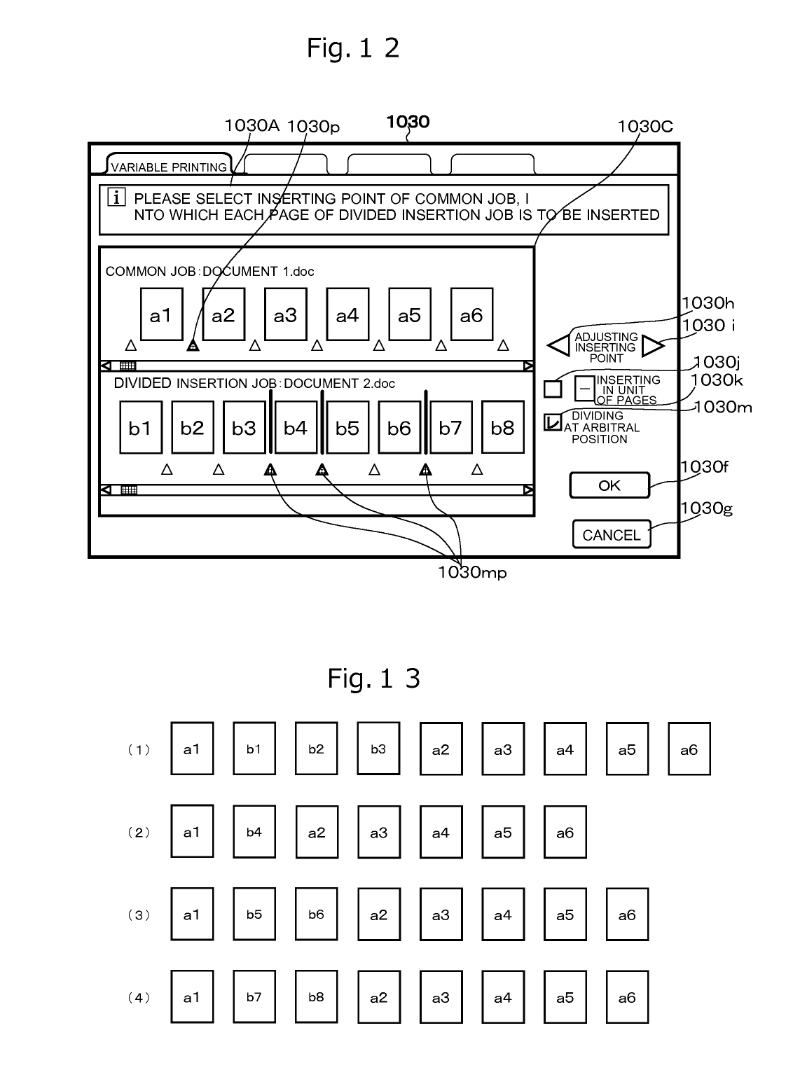

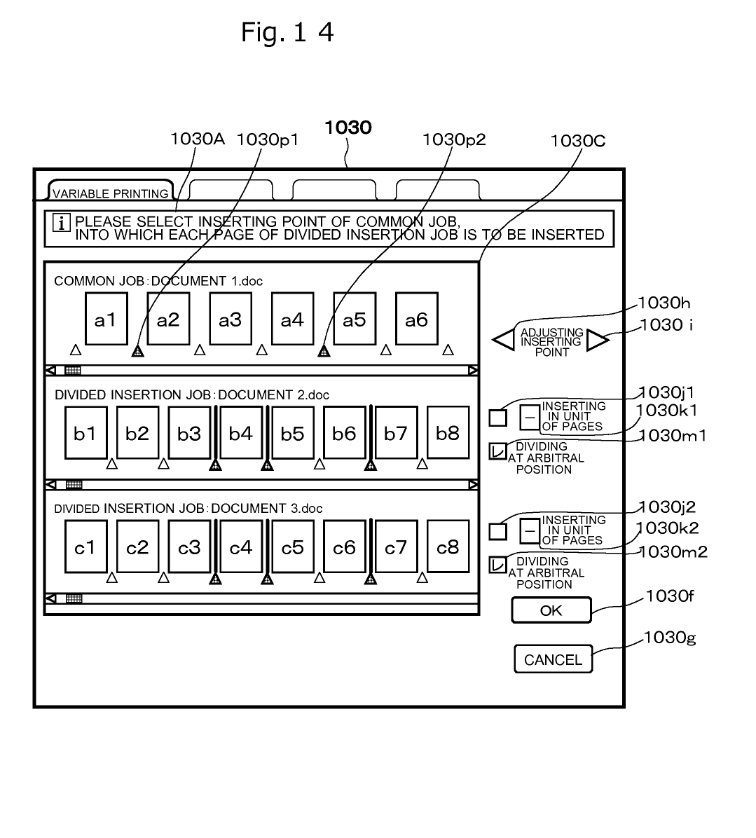

Next, referring to the flowchart shown in FIG. 11, the explanatory schematic diagram of the screen display shown in FIG. 12, and the explanatory schematic diagram of the job status shown in FIG. 13, the operations to be conducted in the image forming apparatus 100, serving as still another embodiment of the present invention, will be detailed in the following as OPERATIONS (3) OF IMAGE FORMING APPARATUS. In this connection, in the explanatory schematic diagram of the screen display and the explanatory schematic diagram of the job status, the reference numbers, attached to the portions same as those aforementioned, are the same as those of the aforementioned portions, respectively, in order to omit or simplify duplicated explanations for them.

Herein, when the user designates the inserting position for the variable printing through the operating section 103 (Step S201; YES, shown in FIG. 11), the control section 101 displays the setting screen 1030 shown in FIG. 12, in which pages (a1, a2, a3 . . . ) to be included in the common job data, the pointer 1030p for indicating the designated inserting position, a checking box 1030m for inputting an instruction for dividing the divided insertion job data at an arbitral position and a dividing position pointer 1030mp for designating the arbitral dividing position, are also displayed, so as to accept the user's operations for selecting the job data, designating the inserting position and designating the dividing position (Step S202, Step S203 shown in FIG. 11).

Herein, the example shown in FIG. 12 indicates such a state that the pointer 1030p, designating the inserting position, is positioned between the 1-page and the 2-page of the common job data, and when the divided insertion job data includes “b1” through “b8” pages, the operations for dividing the divided insertion job data into four sections, including “b1” through “b3” pages, “b4” page, “b5” through “b6” pages and “b7” through “b8” pages, are designated. Accordingly, the control section 101 acquires the equation of “TotalJobNum”=4, serving as a total number of divided sections of the divided insertion job data (Step S204 shown in FIG. 11).

Successively, the control section 101 sets an initial value of “x”, serving as a variable number, at 1 (Step S206 shown in FIG. 11), in order to generate jobs from “1” to “TotalJobNum” (Step S205 shown in FIG. 11). Then, the control section 101 copies and combines pages, being valid among the pages up to the inserting position of the common job data, with the job concerned (Step S207 shown in FIG. 11). In this connection, when a setting of valid or invalid is not established, all of such the cases are regarded (deemed) as valid in principle.

Still successively, the control section 101 copies and combines pages, being valid among the pages up to the divide page of the “x”-th divided insertion job data, with the jobs, the number of which is equivalent to the number of divided sections of the divided insertion job data (Step S208 shown in FIG. 11). The control section 101 repeats the abovementioned operation (Step S209; NO, through Step S207, shown in FIG. 11), until the processing in regard to all of the pages of the “x”-th job data have been completed. After that, if the “x+1”-th job exists (Step S210; YES, shown in FIG. 11), the control section 101 repeats the operation for applying the processing in Step S207 and Step S208 to the “x+1”-th job, as well.

Still successively, with respect to all of the jobs from “1” to “TotalJobNum”, the control section 101 conducts the operations for copying and combining valid pages, located next to the inserting position of the common job data (Step S212 shown in FIG. 11). Through the abovementioned process, with respect to the all of the jobs, the control section 101 creates the image forming use job data in which the common job data and the insertion job data are combined with each other.

Yet successively, with respect to the print settings of each of the image forming use job data sets, the number of which is equivalent to “TotalJobNum”, the control section 101 conducts controlling operations so as to take over the print settings of the print setting valid page in the each of the insertion page data (Step S213 shown in FIG. 11). By establishing the print settings as abovementioned, it becomes possible to conduct the operations for establishing the print settings for the variable printing in detail without employing the exclusive application program to be executed for implementing complicated processing.

The schematic diagram shown in FIG. 13 indicates the state of the image forming use jobs, which are finally created as the data to be employed for the variable printing, under the settings shown in FIG. 12. As shown in FIG. 13, by inserting the insertion use page data sets for every arbitral number of pages into the common job data including 6 pages, respectively, the total four jobs, corresponding to “TotalJobNum”, are created.

Then, the control section 101 stores the image forming use job data, created through the abovementioned processing, into the data storage section 130, etc., in an arbitral format, such as a single job data format, a plural job data format, etc. Even in this case, it becomes possible to conduct the variable printing without employing the exclusive application program and without requiring any expertise or mastership of the user, while reducing the data transferring amount

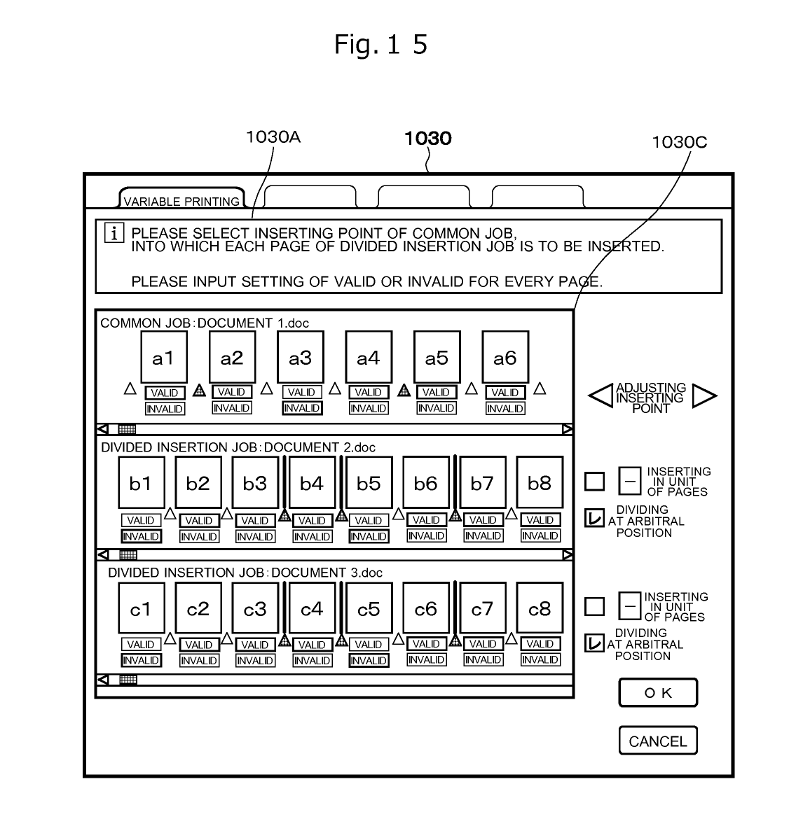

Further, as indicated in the explanatory schematic diagram of the screen display shown in FIG. 14, it is possible to establish a plurality of inserting positions in the common job data, such as a pointer 1030p1 and a pointer 1030p2 positioned between the “a1” and “a2” pages and between the “a4” and “a5” pages, respectively, so as to allot a plurality of divided insertion job data sets to them. In this case, when “y” inserting positions are established in the common job data, it becomes possible to allot “y” sets of the divided insertion job data. Further in this case, the divided insertion job data may be divided either at an arbitral position, or in a unit of the predetermined number of pages. According to the abovementioned feature, it becomes possible to conduct various kinds of variable printing operations without employing the exclusive application program and without requiring any expertise or mastership of the user.

Still further, it is possible to display the setting screen 1030 as indicated in the explanatory schematic diagram of the screen display shown in FIG. 15, in which a pair of setting items for selecting valid or invalid is provide for each of the pages included in both the common job data and the divided insertion job data, so that the control section 101 can establish a setting to reflect pages, for each of which the user selects the setting item of valid, onto the image forming use job, while another setting not to reflect (include) other pages, for each of which the user selects the setting item of invalid, onto (into) the image forming use job. According to the above feature, it becomes possible for the user to conduct the image forming operations based on the arbitral page settings in the variable printing, more effectively than ever. Further in this case, since it is unnecessary to apply any change processing to the common job data and the divided insertion job data, both originally provided, it becomes unnecessary to apply any processing to the original job data, resulting in such an advantageous feature that a wasted processing time is not generated.

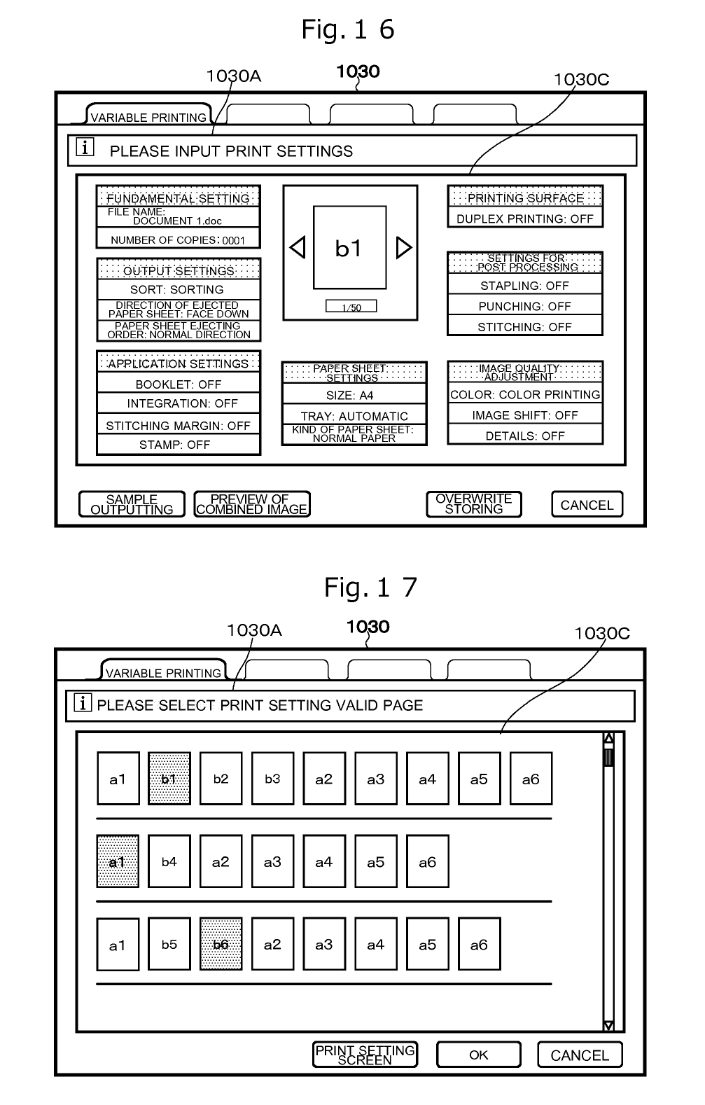

Still further, the control section 101 displays a print setting screen 1030C as shown in FIG. 16 onto the operating section 103, so as to make it possible to conduct the operations for establishing various kinds of print settings for the insertion use page data, including: fundamental settings, such as a number of copies, etc.; paper sheet settings in regard to a tray to be used, a kind of paper sheet, etc.; image quality adjustments in regard to a selection of monochrome or color, etc.; a setting of duplex or single sided printing in regard to a printing surface; output settings, such as a sort, an ejection surface, an ejecting order, etc.; settings for post processing, such as a stapling, a punching, a binding, etc.; application settings in regard to a booklet, a stamp, etc.; and so on, based on the inputting operations conducted by the user.

Then, the print settings, abovementioned, are established for every one of the pages (insertion use page data) included in the divided insertion job data, so as to establish the print settings for every set of the image forming use job data, based on the print settings of the insertion use page data concerned. Accordingly, it becomes possible to conduct the operations for establishing the print settings for the variable printing in detail without employing the exclusive application program to be executed for implementing complicated processing. In other words, in case of the direct mail printing, it becomes possible to send the print products, contents of which are different from each other, to the different customers.

Still further, the control section 101 displays the setting screen 1030 as shown in FIG. 16 onto the operating section 103, so as to make it possible to accept the operation for selecting the print setting valid page, conducted by the user by depressing a corresponding area of the touch panel. In the setting screen 1030 shown in FIG. 17, with respect to the image forming use job into which the pages “b1” through “b3” are inserted, the print settings established for the page “b1” become valid. With respect to the image forming use job into which the page “b4” is inserted, the print settings of the common job data, established for the page “a1”, become valid, instead of those for the page “b4”. With respect to the image forming use job into which the pages “b5” through “b6” are inserted, the print settings established for the page “b6” become valid. Accordingly, depending on the user's intention, it becomes possible not only to employ the print settings of the insertion use page data included in the divided insertion job data, but also to employ the print settings of the original common job data.

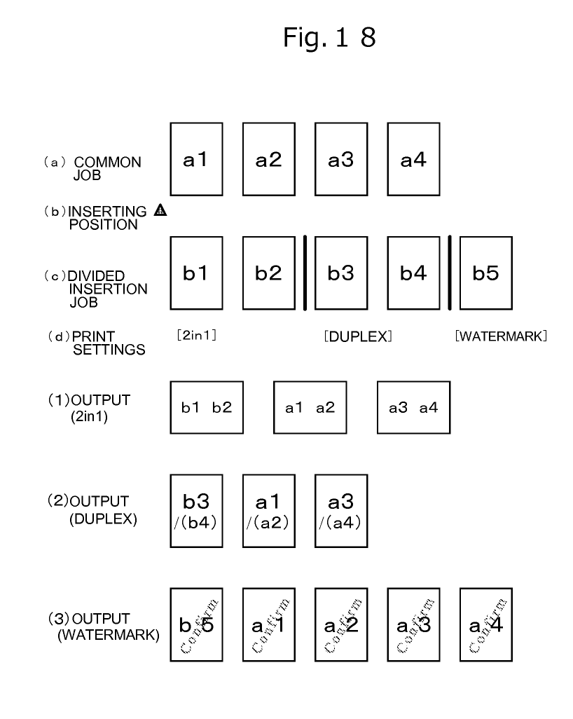

FIG. 18 shows an explanatory schematic diagram indicating an example of correspondence between the print settings of the insertion use page data included in the divided insertion job data and an image forming output example based on the image forming use job data. In the example shown in FIG. 18, the common job data constituted by the page data sets of “a1” through “a4”, as shown in line (a) of FIG. 18, exists; the inserting position is designated as a position in front of the page “a1”, as shown in line (b) of FIG. 18; and three sets of the divided insertion job data, respectively including the pair of pages “b1” and “b2”, the pair of pages “b3” and “b4”, and the page “b5”, as shown in line (c) of FIG. 18, exist. In this connection, the print settings in regard to the pages “b1”, “b3” and “b5” are the 2in1 integration printing, the duplex image forming operation and the watermark, respectively, and it is assumed that these print settings are valid, as shown in line (d) of FIG. 18.

Under the above-established conditions, in the image forming use job into which the pages “b1” and “b2” are inserted, as shown in line (1) of FIG. 18, the 2in1 integration printing is implemented as a whole. Further, in the image forming use job into which the pages “b3” and “b4” are inserted, as shown in line (2) of FIG. 18, the duplex image forming operation is implemented as a whole. Still further, in the image forming use job into which the page “b5” is inserted, as shown in line (3) of FIG. 18, the image forming operation for adding the watermark is implemented as a whole.

As described in the foregoing, according to the present invention, by making the print settings different from each other for every one of the image forming use job data, based on the print settings of the insertion use page data, it becomes possible to conduct the operations for establishing the print settings for the variable printing in detail without employing the exclusive application program to be executed for implementing complicated processing.

Incidentally, although the embodiment, in which the setting screen 1030 is displayed onto the operating section 103 in order to conduct the various kinds of operations and settings, has been described as the concrete example of the present invention in the foregoing, the scope of the present invention is not limited to the aforementioned embodiment. For instance, alternatively, the printing system can be so constituted that the setting screen 1030 is displayed onto the display screen of the computer terminal device owned by the user, so that the operations and the settings, being same as those described in the foregoing, are implemented for the control section 101 by using a pointing device and the setting screen 1030 provided in the user's computer site.

### EXPLANATION OF NOTATION

100 an image forming apparatus
101 a control section
102 a communication section
103 an operating section
110 an inputting section
130 a data storage section
140 a volatile storage section
150 an image processing section
160 an image forming section

What is claimed is:

1. An image forming apparatus, comprising:
an inputting section to input first job data, serving as a base data group, and second job data, serving as an assembly of data for insertion, each of which is to be inserted into a inserting position of the first job data, therefrom;
a control section that divides the second job data into plural sets of the data for insertion so as to respectively insert the plural sets of the data for insertion into inserting positions of the first job data, each of which is the inserting position, and combines them with each other, in order to create a plurality of image forming use job data; and
an image forming section to form images based on the plurality of image forming use job data.

2. The image forming apparatus of claim 1,
wherein the control section makes “n” copies of the first job data, and divides the second job data into “n” sets of the data for insertion, so as to respectively insert the “n” sets of the data for insertion into the inserting positions, each of which is provided in each of the “n” copies of the first job data.

3. The image forming apparatus of claim 1,
wherein the first job data is defined as common job data to be commonly employed among the plurality of image forming use job data; and
wherein the second job data is defined as divided insertion job data, serving as the assembly of data for insertion that is constituted by insertion use page data, being dividable into page data for every page.

4. The image forming apparatus of claim 1,
wherein insertion use page data, created by dividing the second job data for every single page or for every plurality of pages or at an arbitral position, can be inserted into the inserting position as the data for insertion.

5. The image forming apparatus of claim 1,
wherein a plurality of inserting positions is settable, and a plurality of the second job data is employed in conformity with the plurality of inserting positions.

6. The image forming apparatus of claim 1,
wherein, based on settings established for every one of the data for insertion, the control section establishes settings for implementing an image forming operation in regard to every one of the image forming use job data.

7. An image forming method, comprising:
input first job data, serving as a base data group, and second job data, serving as an assembly of data for insertion, each of which is to be inserted into a inserting position of the first job data;
dividing the second job data into plural sets of the data for insertion so as to respectively insert the plural sets of the data for insertion into inserting positions of the first job data, each of which is the inserting position;
combining the plural sets of the data for insertion with the first job, so as to create a plurality of image forming use job data; and
forming images based on the plurality of image forming use job data.

8. The image forming method of claim 7,
wherein the step of creating the plurality of image forming use job data further includes:
making “n” copies of the first job data;
dividing the second job data into “n” sets of the data for insertion; and
respectively inserting the “n” sets of the data for insertion into the inserting positions, each of which is provided in each of the “n” copies of the first job data.

9. The image forming method of claim 7,
wherein the first job data is defined as common job data to be commonly employed among the plurality of image forming use job data; and
wherein the second job data is defined as divided insertion job data, serving as the assembly of data for insertion that is constituted by insertion use page data, being dividable into page data for every page.

10. The image forming method of claim 7,
wherein insertion use page data, created by dividing the second job data for every single page or for every plurality of pages or at an arbitral position, can be inserted into the inserting position as the data for insertion.

11. The image forming method of claim 7,
wherein a plurality of inserting positions is settable, and a plurality of the second job data is employed in conformity with the plurality of inserting positions.

12. The image forming method of claim 7,
wherein, based on settings established for every one of the data for insertion, the control section establishes settings for implementing an image forming operation in regard to every one of the image forming use job data.
